(19) United States
(12) Patent Application Publication
(10) Pub. No.: US 2010/0212475 A1
(43) Pub. Date: Aug. 26, 2010

(54) TUNING OR TRAINING DEVICE

(75) Inventor: Rob Toulson, Cambridgeshire (GB)

Correspondence Address: EGBERT LAW OFFICES, 412 MAIN STREET, 7TH FLOOR, HOUSTON, TX, 77002, US

(73) Assignee: ANGLIA RUSKIN UNIVERSITY, Chelmsford, Essex (GB)

(21) Appl. No.: 12/668,641

(22) PCT Filed: Jun. 13, 2008
(86) PCT No.: PCT/GB2008/002017

§ 371 Date: May 3, 2010

(30) Foreign Application Priority Data
Jul. 13, 2007 (GB) 0713649.2

(51) Int. Cl. G10H 1/44

(52) U.S. Cl. 84/454

(57) ABSTRACT

A device for tuning a percussion instrument or training a voice has a processor which is adapted to receive an electronic signal corresponding to an acoustic impulse produced by the percussion instrument or voice. The processor is further adapted to analyse the signal to generate one or more characteristics of the signal. The device also has a display connected to the processor which displays the generated characteristics. The one or more characteristics include any one or any combination of a time-domain characteristic of the signal, a plurality of fundamental and/or harmonic frequencies of the signal, and a frequency spectrum of the signal.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a tuning or training device, and particularly, but not exclusively, to a device for tuning percussion instruments.

2. Description of Related Art Including Information Disclosed Under 37 CFR 1.97 and 37 CFR 1.98.

A percussion instrument, such as a drum or a timpani, may have many tuning mechanisms for altering the characteristics of the sound produce by the instrument.

For example, the sound produced by a snare drum is affected by the unique vibratile properties of the drum, and is further complicated by the two taught skins at either side of the drum, each of which may be tensioned by a number of tension screws attached around the perimeter of the drum.

However, many percussionists do not have the necessary skills to tune their instrument unassisted.

Known devices for assisting percussionists with tuning include mechanical aids that help to ensure that tension screws are set to constant or desired tensions.

Another approach, proposed in U.S. Pat. No. 4,741,242, is to analyse the sound frequency produced by a drum and visually display the note in the musical scale whose frequency is closest to the frequency of the analysed sound, and whether the note being played is sharp or flat to the displayed note.

An alternative approach, proposed in U.S. Pat. No. 6,925,880, is to excite a drumhead with acoustic energy of a known frequency, and using a microphone to measure the drumhead's response. In particular, the voltage from the microphone is measured and displayed by a voltmeter. A voltage amplitude peak then corresponds to a resonant frequency of the drumhead.

### BRIEF SUMMARY OF THE INVENTION

In general terms, the present invention provides a device for tuning a percussion instrument having:

a processor for receiving an electronic signal corresponding to an acoustic impulse produced by a percussion instrument, and for analysing the signal to generate one or more characteristics of the signal; and

a display connected to the processor which displays the generated characteristics.

Thus a user, viewing the display, can tune the percussion instrument to achieve one or more desired signal characteristics.

In particular, an aspect of the present invention is at least partly based on the realisation that the perception by a listener of sound produced by a percussion instrument is not just dependent on a single fundamental frequency of the acoustic impulse produced by the percussion instrument, but is often strongly affected by time-domain characteristics of the impulse, such as the attack time and the decay time, and on harmonic frequencies or further fundamental frequencies of the impulse. Indeed, in many circumstances, a single frequency of itself does not adequately characterise how sound from a percussion instrument will be perceived by a listener.

Thus a first aspect of the present invention provides a device for tuning a percussion instrument having:

a processor which is adapted to receive an electronic signal corresponding to an acoustic impulse produced by a percussion instrument, and is further adapted to analyse the signal to generate one or more characteristics of the signal; and

a display connected to the processor which displays the generated characteristics; wherein the one or more characteristics include any one or any combination of: a time-domain characteristic of the signal, a plurality of fundamental and/or harmonic frequencies of the signal, and a frequency spectrum of the signal.

Thus, in contrast to the approaches of U.S. Pat. No. 4,741,242 and U.S. Pat. No. 6,925,880 which effectively provide a user at any one time with information about a single frequency, the tuning device of the present invention can provide a user with the range of characteristics that may be needed to properly assess how changes to the instrument tuning will affect the perception by a listener of sound produced by the instrument. For example, the device can simultaneously display the prominent frequencies of the signal.

The time-domain characteristic of the signal may include any one or any combination of: a time domain waveform of the signal, the attack time of the signal, and the decay time of the signal. The attack and decay times, in particular, have a significant impact on how the sound of the instrument is perceived.

In particular, the time-domain characteristic of the signal may include respective attack and/or decay times for a plurality of frequency bands, for example a low frequency band, a midrange band, and a high frequency band.

Preferably, the device further has electronic storage for storing electronic signals corresponding to acoustic impulses produced by a percussion instrument, the processor being adapted to receive the electronic signals from the electronic storage. With this facility, the user can, for example, tune the instrument to replicate a stored reference sound. The processor may be adapted to send electronic signals to the electronic storage so that e.g. the user can store reference sounds.

The processor may be further adapted to provide tuning instructions for tuning the percussion instrument so as to achieve a predetermined reference tuning, the display then displaying the tuning instructions. The predetermined reference tuning may, for example, be defined by a reference signal stored in the electronic storage.

The processor can be adapted to analyse a plurality of signals to generate one or more averaged characteristics of the signals. In this way, if the instrument sound varies from strike to strike (e.g. the sound produced by a drum can vary depending on the strike force and the strike position on the skin), the tuning can be in respect of the average sound.

The processor can be adapted to analyse a plurality of signals from different locations around an instrument, such as drum head. A tuning which provides a uniform acoustic profile across the instrument can then be achieved. For example, in relation to a drum head, tuning instructions provided by the processor can specify how the screws or lugs which tension the drum head should be adjusted.

The processor can further be adapted to analyse a change in frequency response over time or specified time periods. For example, the frequency spectrum of the signal may be different in the early part of the signal relative to that in the decay tail. The processor can therefore be adapted to display one or more characteristics (such as a frequency spectrum) during respective windowed periods, or a continuous plot of a characteristic against time (for example, a three-dimensional profile of instantaneous frequency spectrum against time).

Alternatively or additionally, the display can simultaneously display generated characteristics for a plurality of electronic signals.

Preferably, the device further has a speaker connected to the processor which reproduces the acoustic impulse corresponding to the electronic signal.

Preferably, the device further has one or more sensors, such as microphones, for receiving the acoustic impulse produced by the percussion instrument, and for converting the impulse into the electronic signal, the processor being connected to the or each sensor. A sensor may be a part of the instrument being tuned. For example a sensor may be embedded in or joined to a drumstick or other percussion instrument impact device. Alternatively, or additionally, a sensor may be installed in a drum.

The processor can be triggered to analyse the electronic signal when the signal surpasses an intensity threshold. With such an arrangement, it is not necessary for the user to ready the device prior to analysing a signal.

Preferably, the device is in the form of a handheld unit. This is particularly advantageous as it promotes convenience of use and allows the user easily to transport the device and so use it to tune instruments in different locations. The handheld unit may be interfaceable to a computer system from which reference signals can be loaded to the handheld unit. The computer system, when interfaced to the handheld unit may extend the functionality of the unit. Thus complex setup and analysis tasks may be performed while the handheld unit and computer system are interfaced, while instrument tuning using the handheld unit can be performed when it is disconnected from the computer system.

Preferably, the device has a headphone socket e.g. to allow audible comparison of actual tuning against a reference signal.

A further aspect of the invention provides a computer program for:

receiving an electronic signal corresponding to an acoustic impulse produced by a percussion instrument;

analyzing the signal to generate one or more characteristics of the signal; and

instructing a display to display the generated characteristics; wherein the one or more characteristics include any one or any combination of: a time-domain characteristic of the signal, a plurality of fundamental and/or harmonic frequencies of the signal, and a frequency spectrum of the signal.

Another aspect of the invention provides a computer program product carrying the computer program of the previous aspect.

The computer program and computer program product aspects of the invention correspond to the device of the first aspect. Consequently, any one or any combination of the optional features of the first aspect applies also to these aspects.

A further aspect of the invention provides the use of the device according to the first aspect for tuning a percussion instrument.

Indeed, although the present invention was conceived in relation to the tuning of percussion instruments, the device of the first aspect may be used to tune musical instruments (including non-percussion instruments) generally.

A further aspect of the invention provides the use of the device as a vocal trainer. Analysis of a singer's voice can be used to measure vocal musical qualities such as pitch, harmonic content and vibrato. A vocalist can therefore use the device to assess and help train towards an improved musical voice.

### BRIEF DESCRIPTION OF THE SEVERAL VIEWS OF THE DRAWINGS

Embodiments of the invention will now be described by way of example with reference to the accompanying drawings in which:

FIG. 1 shows a graphical view of a typical time-domain waveform for an acoustic impulse produced by a percussion instrument;

FIG. 2 shows graphical views of a time domain waveform and the corresponding frequency spectrum;

FIG. 3 shows graphical views of a time domain waveform and the corresponding frequency spectra plotted for consecutive sampling windows;

FIG. 4 shows a schematic view of a device embodying the present invention;

FIG. 5 shows schematically another device embodying the present invention;

FIG. 6 shows a schematic view of a display window which can appear on a screen of the device of FIG. 4 or 5;

FIG. 7 shows a schematic view of another display window, the display window showing time-domain characteristics of a signal for a plurality of frequency bands; and

FIGS. 8A and 8B show schematic views of respective tuning guide display windows for tuning a drum when (a) the drum exhibits even pitch and (b) the drum exhibits uneven pitch.

### DETAILED DESCRIPTION OF THE INVENTION

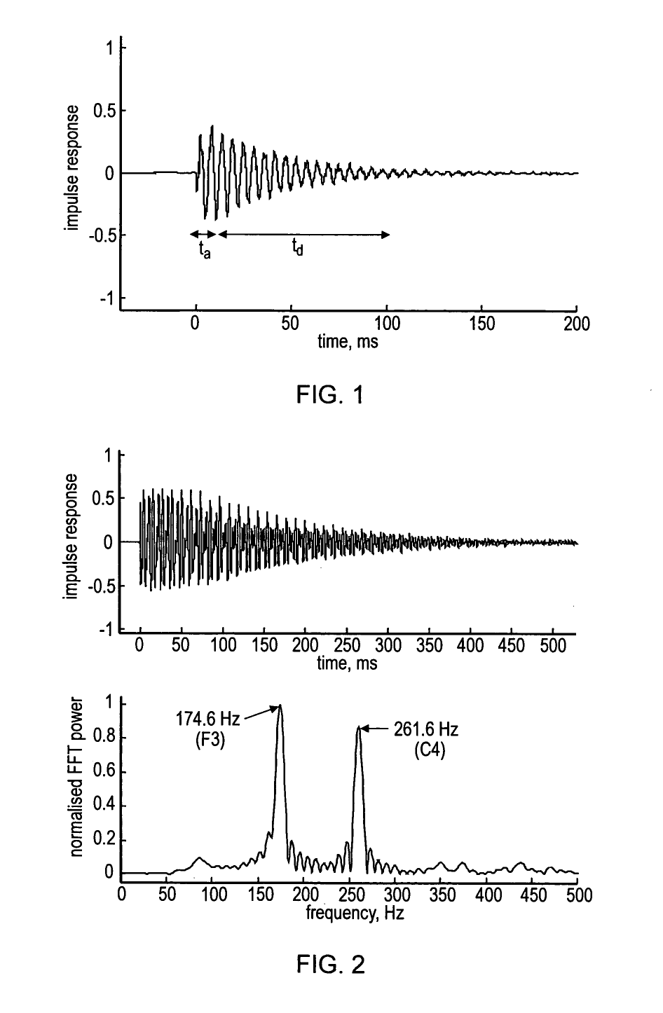

FIG. 1 shows a typical time-domain waveform for an acoustic impulse produced by a percussion instrument, such as a snare drum.

The attack time, tₐ, indicated on the waveform is the time for the amplitude of the waveform to grow from zero at the beginning of the impulse to a maximum.

The decay time, t_{d}, indicated on the waveform is the decay time of the amplitude of the waveform. The decay time can be measured by any standard decay measurement technique. For example, the decay time can be measured by calculating the time from the maximum amplitude to an amplitude (typically defined as a percentage, e.g. 10%, of that maximum) at which the impulse is effectively ended.

tₐ and t_{d}, which have a significant effect on how sound produced by a percussion instrument is perceived, can be altered by varying the tuning of the instrument. In particular, in relation to drums, they can be varied by adding damping to the taught drum skins.

FIG. 2 shows an impulse time-domain waveform of a tuned drum and its associated frequency spectrum.

The lowest fundamental frequency of the impulse is the strong peak at 174.6 Hz. This corresponds to the note F3 on the standard musical scale. However, there are other significant peaks, and this particular drum has been tuned such that its second fundamental vibration mode is at 261.6 Hz. This frequency corresponds to the note C4 on the standard musical scale. If such other peaks are significant or are harmonics of the fundamental frequency, then the percussion instrument may produce a “pitched” or “tuned” sound. If there are no obvious fundamental peaks in the frequency spectra, then the percussion instrument may produce an “unpitched” or “untuned” sound.

By varying the tuning of the instrument it can therefore be possible to produce a tuned sound and/or to change the most prominent fundamental frequency, having a significant effect on how sound produced by the instrument is perceived.

More generally, percussion instruments can be tuned to have fundamental frequencies relative to the standard musical scale. It is therefore possible to optimise the sound of the instrument so that its vibratile characteristics are tuned to a musical scale. An instrument can furthermore be optimised to be musically tuned relative to other percussion instruments within a percussion set. Furthermore the instrument can be tuned relative to the instruments of other (non-percussion) instruments within a musical ensemble.

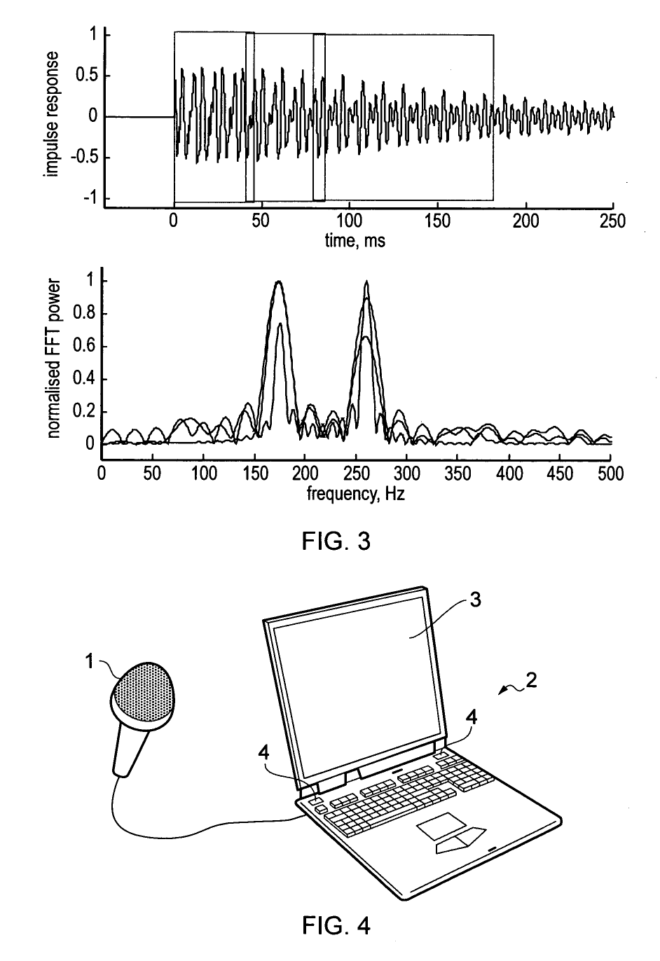

FIG. 3 shows a part of the same waveform data as in FIG. 2, except that the frequency plot shows three different frequency spectra calculated over three consecutive time windows. It can be seen that the 174.6 Hz peak is strongest during the initial period of the waveform. However, during the decay of the waveform the 261.6 Hz peak becomes strongest. The first part of the waveform can therefore be analysed for tuning lower fundamental vibration modes, and similarly the latter part of the waveform can be analysed for tuning higher fundamental modes.

FIG. 4 shows schematically a device embodying the present invention. The device comprises a microphone 1 connected to a laptop computer 2.

The microphone 1 receives an acoustic impulse and converts the impulse into a corresponding electronic signal which it sends to the laptop computer. The computer is programmed to determine time-domain characteristics of the signal and also to fast Fourier transform (FFT) the signal. It further programmed to display characteristics of the signal on its screen 3.

Further, the computer can reproduce the original acoustic impulse via its speakers 4, and can store the signal in or retrieve reference or previously captured signals from its hard drive or RAM.

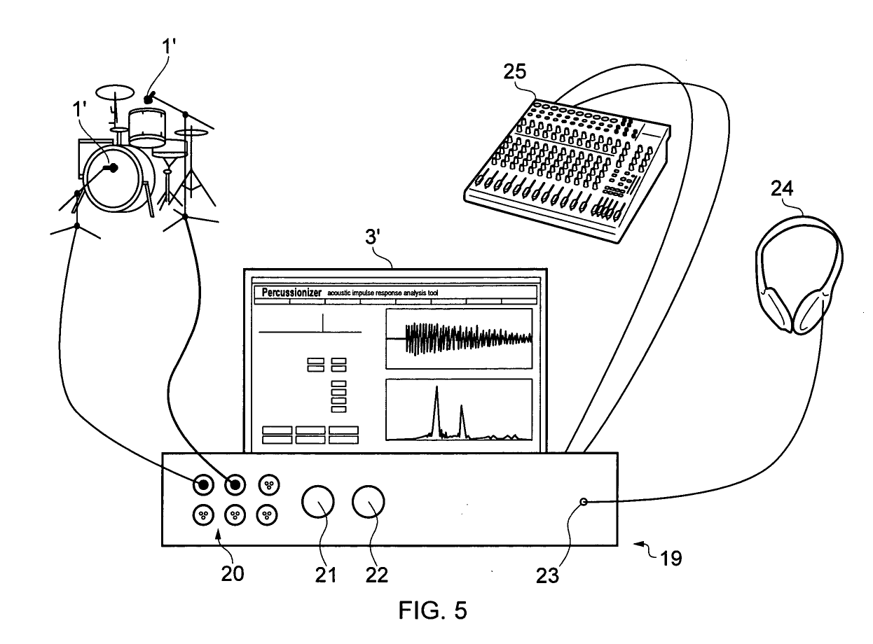

FIG. 5 shows schematically another device embodying the present invention. The device comprises an embedded analysis and tuning system 19 featuring: a touch screen display 3′, multiple microphone inputs 20 with an input select 21 and signal gain control 22, one or more microphones 1′ being attachable at inputs 20 for recording a percussion instrument, an audio output 23 attachable to headphones 24, and bypass outputs (not shown) to allow microphone signals to be forwarded to a studio mixing desk 25.

The microphone(s) 1′ receive acoustic impulses and convert the impulses into corresponding electronic signals which are sent to the embedded tuning system 19. A single microphone input can be selected by the input select 21 and the signal level can be amplified or attenuated as required by the input gain control 22.

The embedded system 19 is programmed to determine time-domain characteristics of the signal and also to fast Fourier transform (FFT) the signal. It is further programmed to display characteristics of the signal on its touch screen 3′ which can also be used to activate and control the analysis system features.

Further, the embedded system can reproduce the original acoustic impulse via the audio output 23, and can store the incoming signal or retrieve reference or previously captured signals from its hard drive or RAM.

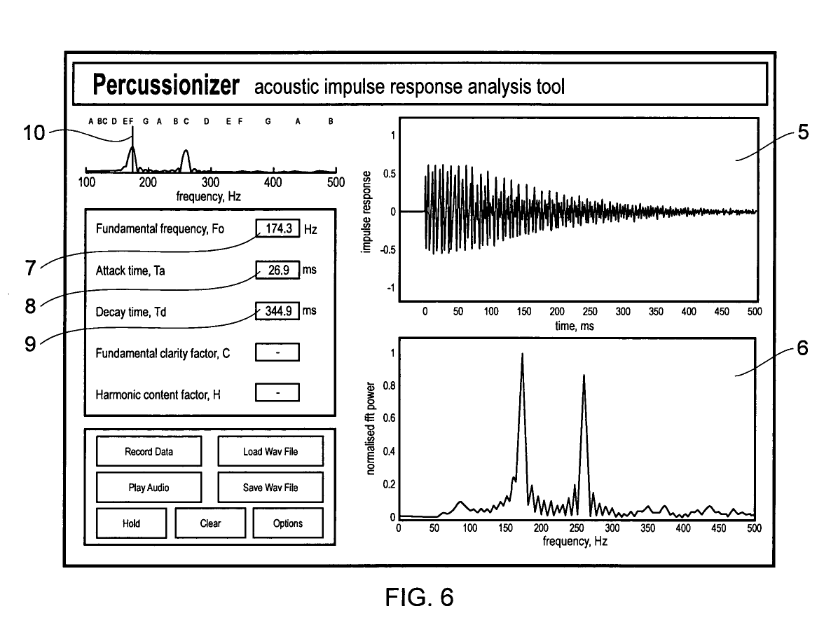

FIG. 6 shows a display window which can appear on the screen 3, 3′ of the device of FIG. 4 or 5. The display window shows the time domain waveform 5 of the signal, the frequency spectrum 6 of the signal from the FFT, and values of the fundamental frequency 7, attack time 8, and decay time 9 of the signal. Further characteristics can also be determined and displayed, such as a fundamental clarity factor (i.e. the width(s) of the fundamental peak(s)) and a harmonic content factor which displays a value indicating the strength and presence of harmonics in the waveform. The frequency data can also be plotted on a musical scale chart 10 to show how fundamental and harmonic peaks align with musical notes.

By viewing the display, a user can see how adjustments to the tuning of a percussion instrument affect the characteristics of the sound produced by that instrument. The user can, for example, tune the instrument so that its fundamental frequency matches the key of other instruments that are playing. The user can use the device to ensure an instrument produces a consistent sound, or to analyse another percussionist's sound so that the user's instrument can be tuned to replicate that sound.

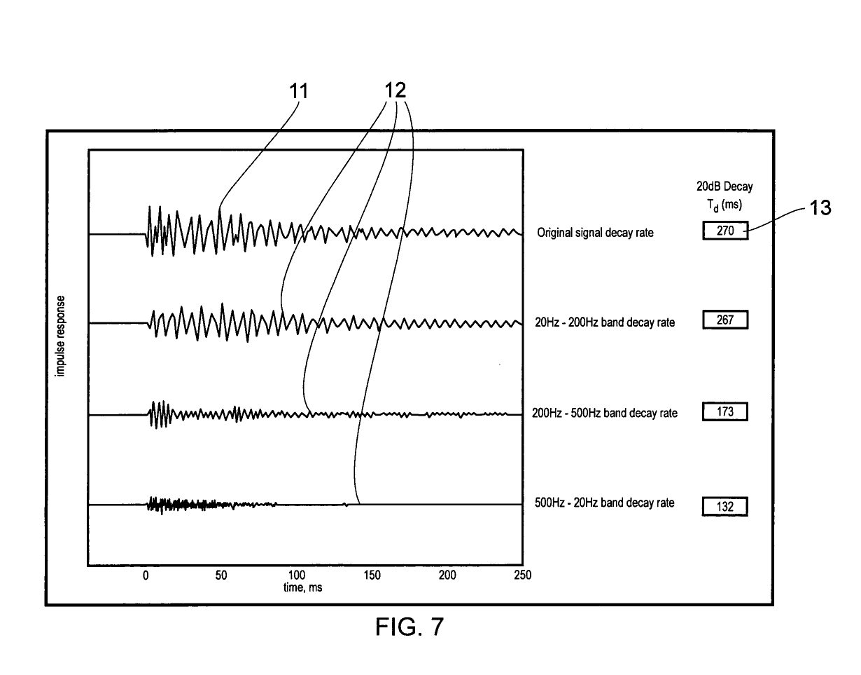

FIG. 7 shows another display window which can appear on the screen 3, 3′ of the device of FIG. 4 or 5. This window has an upper trace 11 which is the time-domain waveform for an acoustic impulse produced by the instrument, and three lower traces 12 which are respectively (from top to bottom) the time-domain waveforms for the 20-200 Hz, 200-500 Hz and 500 Hz-20 kHz frequency bands of the upper waveform. The display allows the decay rates of different components of the acoustic impulse to be visualised. The right hand side of the window displays the respective 20 bB decay times 13 of the waveforms.

Conveniently, analysed acoustic signals can be stored electronically by the device. The device may also have a library of stored reference signals. These reference signals can allow custom benchmarking of tuning setups. Conveniently, benchmarks can be shared amongst musicians, or reference signals corresponding to benchmarks from professional musicians can be loaded.

The device can further be programmed to provide a tuning guide so that, for a particular type of percussion instrument, the user is provided with step-by-step instructions on how to vary the tuning of the particular instrument to achieve a specific sound defined e.g. by a reference signal stored on the device.

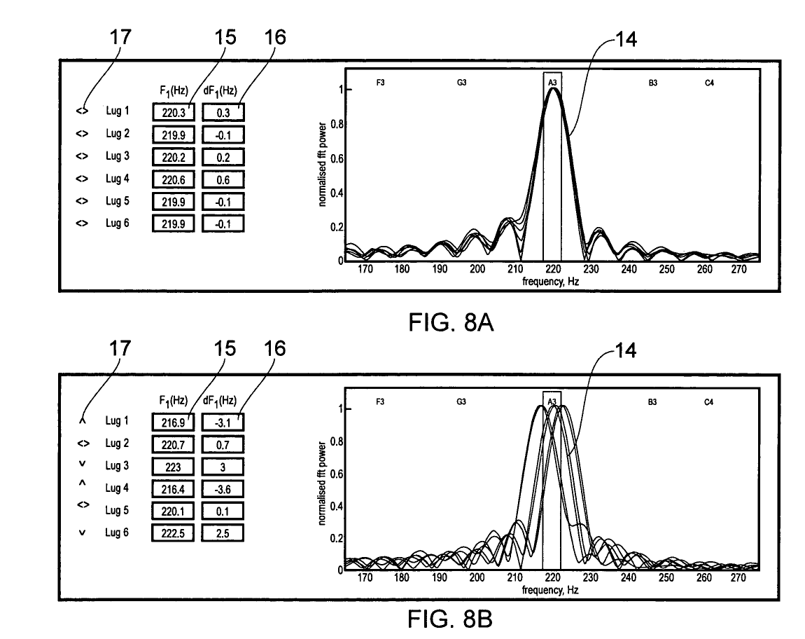

For example, FIG. 8(a) shows a tuning guide for a drum which has six tightening lugs at spaced positions around the circumference of a drum head. The guide is in the form of a display window which appears on the screen 3, 3′ of the device of FIG. 4 or 5. The right hand side of the display window has traces 14 for six frequency spectra obtained by fast Fourier transforming the signals recorded by respective microphones, each microphone being located adjacent a corresponding tightening lug. The display window also shows the peak value (F1) 15 of the respective spectra, and the distance of that peak value (dF1) 16 from a desired pitch (in this case 220 Hz). The six indicators 17 at the left hand side of the window indicate if the lugs should be tightened or loosened so that all six locations on the drum exhibit the same pitch within an acceptable tolerance.

In FIG. 8(a), the six locations exhibit essentially the same pitch, and no adjustment is needed. However, in FIG. 8(b), which shows a corresponding tuning guide display window for the drum now exhibiting uneven pitch around 220 Hz, the indicators 17 for Lug 1 and Lug 4 indicate that tightening of these lugs is required, while the indicators 17 for Lug 3 and Lug 6 indicate that loosening of these lugs is required. The uneven pitch is also evident in the spreading of the frequency spectra 14 and in the values of F1 and dF1.

The analysis, display and optionally the tuning guide software with which the device is programmed can be made available on a computer program product, such as CD, memory stick, or floppy disc, for loading on to other computers.

The device of FIG. 4 or 5 and microphone(s) 1, 1′ are portable and can be readily set up and used in different locations. However, another embodiment of the device (not shown) comprises a dedicated, handheld unit that contains at least a processor for receiving and analysing the signal and a display for displaying the signal characteristics. Conveniently, the dedicated handheld unit can be smaller and more robust than the device of FIG. 4 or 5. The unit may also contain electronic storage for signals and/or a speaker. The unit may further contain a microphone, although it may be more convenient to provide the microphone as a separate device so that the user does not have to position the unit adjacent an instrument when capturing an acoustic impulse.

While the invention has been described in conjunction with the exemplary embodiments described above, many equivalent modifications and variations will be apparent to those skilled in the art when given this disclosure. For example, although the above embodiments described are described in relation to the tuning of a percussion instrument, the same or different embodiments may be used to tune other instruments or to train a vocalist. Furthermore, the tuning of a percussion instrument might feasibly be performed in the digital domain as a post-processing operation. Accordingly, the exemplary embodiments of the invention set forth above are considered to be illustrative and not limiting. Various changes to the described embodiments may be made without departing from the spirit and scope of the invention.

1. A device for tuning a percussion instrument having:
a processor which is adapted to receive an electronic signal corresponding to an acoustic impulse produced by the percussion instrument, and is further adapted to analyze the signal to generate one or more characteristics of the signal; and
a display connected to the processor which displays the generated characteristics;
wherein the one or more characteristics include any one or any combination of: a time-domain characteristic of the signal, a plurality of fundamental and/or harmonic frequencies of the signal, a frequency spectrum of the signal.

2. A device according to claim 1, wherein the generated characteristics include any one or any combination of: a time domain waveform of the signal, the attack time of the signal, and the decay time of the signal.

3. A device according to claim 1, further having electronic storage for storing electronic signals corresponding to acoustic impulses produced by the percussion instrument, the processor being adapted to receive the electronic signals from the electronic storage.

4. A device according to claim 3, wherein the processor is adapted to send electronic signals to the electronic storage.

5. A device according to claim 1, wherein the processor is further adapted to provide tuning instructions for tuning the percussion instrument so as to achieve respectively a predetermined reference tuning, the display displaying the instructions.

6. A device according to claim 1, wherein the processor is adapted to analyze a plurality of signals to generate one or more averaged characteristics of the signals.

7. A device according to claim 1, wherein the display can simultaneously display generated characteristics for a plurality of electronic signals.

8. A device according to claim 1, further having a speaker connected to the processor which reproduces the acoustic impulse corresponding to the electronic signal.

9. A device according to claim 1, further having a sensor for receiving the acoustic impulse produced by the percussion instrument, and for converting the impulse into the electronic signal, the processor being connected to the sensor.

10. A device according to claim 1, wherein the processor is triggered to analyze the electronic signal when the signal surpasses an intensity threshold.

11. A device to claim 1, wherein the device is in the form of a handheld unit.

12. Use of the device according to claim 1 for tuning a percussion instrument.

13. A computer program product carrying a computer program for:
receiving an electronic signal corresponding to an acoustic impulse produced by a percussion instrument;
analyzing the signal to generate one or more characteristics of the signal; and
instructing a display to display the generated characteristics;
wherein the one or more characteristics include any one or any combination of: a time-domain characteristic of the signal, a plurality of fundamental and/or harmonic frequencies of the signal, and a frequency spectrum of the signal.
